(19) United States
(12) Patent Application Publication
(10) Pub. No.: US 2018/0330330 A1
(43) Pub. Date: Nov. 15, 2018

(54) AGENT SYSTEM FOR A DEVICE

(71) Applicant: Sony Corporation, Tokyo (JP)

(72) Inventors: Tsubasa Tsukahara, Tokyo (JP); Angie Park, Oakland, CA (US)

(73) Assignee: Sony Corporation, Tokyo (JP)

(21) Appl. No.: 15/595,379

(22) Filed: May 15, 2017

(51) Int. Cl. G06Q 10/10; G06Q 10/06; G06F 17/30; G06F 3/16

(52) U.S. Cl. CPC G06Q 10/109; G06Q 10/06311; G06F 17/30029; G06F 3/167; G06F 17/30044; G06F 17/30041; G06F 17/30864; G06F 17/30032

(57) ABSTRACT

Implementations generally relate to an agent system for a device. In some implementations, a method includes determining, at a client device, user information associated with a user. The method further includes fetching relevant information from one or more remote systems based on the user information, where the one or more remote systems are third-party systems, and where the relevant information meets one or more relevance policies. The method further includes providing the relevant information to the user.

### BACKGROUND

Agents are software that function to assist people with basic tasks such as providing information to users. Such information is typically in the form of natural language. A user can request information from an agent using a user input device such as a keyboard, touchpad, voice recognition device, etc. In response, the agent retrieves the information from a database and provides the information on a user output device such as a display screen or by voice. Such information may include the weather, driving directions, etc.

### SUMMARY

Implementations generally relate to an agent system for a device. In some implementations, a method includes determining, at a client device, user information associated with a user. The method further includes fetching relevant information from one or more remote systems based on the user information, where the one or more remote systems are third-party systems, and where the relevant information meets one or more relevance policies. The method further includes providing the relevant information to the user.

A further understanding of the nature and the advantages of particular implementations disclosed herein may be realized by reference of the remaining portions of the specification and the attached drawings.

### BRIEF DESCRIPTION OF THE DRAWINGS

FIG. 1 illustrates a block diagram of an example agent system environment, which may be used for some implementations described herein.

FIG. 2 illustrates a diagram of an example user device being worn by a user, according to some implementations.

FIG. 3 illustrates an example flow diagram for operating an agent system for a device, according to some implementations.

FIG. 4 illustrates an example flow diagram for fetching relevant information for a user, according to some implementations.

FIG. 5 illustrates a block diagram of an agent system, according to some implementations.

FIG. 6 illustrates a block diagram of an example network environment, which may be used for some implementations described herein.

FIG. 7 illustrates a block diagram of an example computing system, which may be used for some implementations described herein.

### DETAILED DESCRIPTION

Implementations described herein enable a user to quickly and intuitively interact with an augmented reality system, which augments the external environment of the user with virtual images that may be either in a local user interface, paired with the local user interface, and/or in a global user interface.

Implementations generally relate to an agent system for a device. In some implementations, a system determines user information associated with a user. For example, the system may determine the user's activity and location. The system fetches relevant information from one or more remote systems based on the user information. For example, the relevant information may include schedule information, recommendations for local restaurants, etc. In various implementations, the remote systems are third-party systems. In various implementations, the relevant information meets one or more relevance policies. For example, a recommendation for a restaurant may be within a certain distance from the user. The system provides the relevant information to the user.

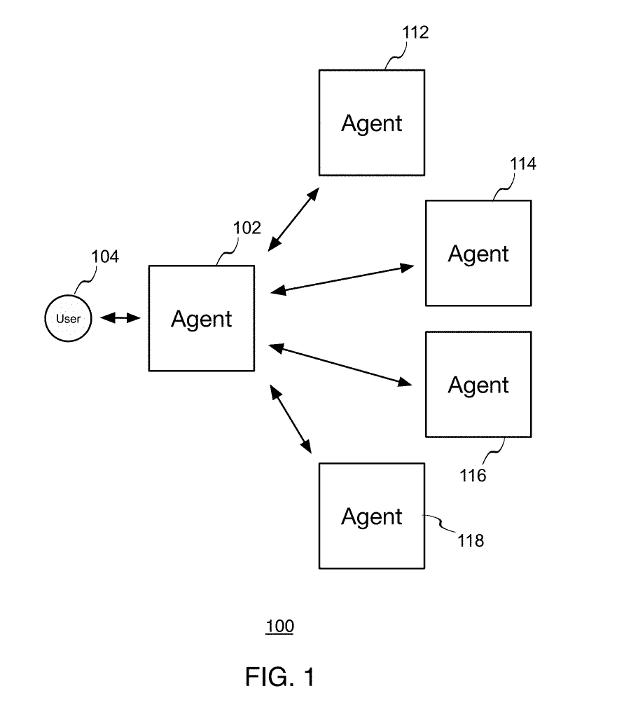

FIG. 1 illustrates a block diagram of an example agent system environment 100, which may be used for some implementations described herein. As shown, agent system environment 100 includes an agent 102 that communicates with a user 104 via a user device (not shown). Various implementations of the user device are described in more detail herein.

In various implementations, agent 102 may be referred to as main agent 102. Agent 102 that communicates with a user 104 via a user device, as indicated herein, and agent 102 also communicates with any number of other agents, such as agent 112, agent 114, agent 116, and agent 118. As such, various implementations provide a one-to-multi agent system, as shown.

As described in more detail herein, agents 112, 114, 116, and 118 provide relevant information to main agent 102, where the relevant information is relevant to user 104. In various implementations, agent 112, agent 114, agent 116, and 118 are third-party agents. For example, agent 112 may be associated with a search engine company, agent 114 may be associated with an online calendar company, etc. Agents 112, 114, 116, and 118 may also be referred to third-party agents 112, 114, 116 and 118, or co-host agents 112, 114, 116, and 118 respectively. For ease of illustration, four co-host agents are shown. Implementations described herein may apply to any number of co-host agents.

In various implementations, each of the co-host agents 112, 114, 116, and 118 may have access to specific fields or specific types of information. For example, agent 112 may specialize in activities (e.g., movie times, etc.), agent 114 may specialize in schedules or calendars, agent 116 may specialize in the weather, agent 118 may specialize in shared online communications such as social media alerts and shared work file updates, etc. The particular specialty of each co-host agent or specific type of information accessed by each co-host agent may vary, and will depend on the particular implementation.

As described in more detail herein, agent 102 interacts with user 104. Agent 102 also makes requests for information and retrieves information from agents 112, 114, 116, and/or 118, and returns requested information to user 104. For example, user 104 may ask agent 102, “Tell me the schedule of Movie A.” Agent 102 may then contact agent 112, and agent 112 may provide agent 102 with details of the schedule for Movie A. Agent 102 may also make a request to agent 114 regarding the personal schedule of user 104, where agent 114 manages the personal schedule of user 104. Agent 114 may then provide agent 102 with the personal schedule of user 104. Agent 102 may then inform user 104 of one or more times that Movie A starts (e.g., 6:30 pm, 9:00 pm, etc.). Agent 102 may also inform user 104 that user 104 is available at that time. In some implementations, agent 102 may cause other agents (e.g., agent 112, agent 114, etc.) to reply directly and separately to user 104.

Implementations describe herein have various benefits. For example, user 104 may communication with one main agent for a variety of information instead of needing to communicate with multiple agents. Also, because agent 102 retrieves information from multiple different co-host agents, which may be third-party agents, the system of agent 102 need not store, manage, and analyze substantially large amounts of data.

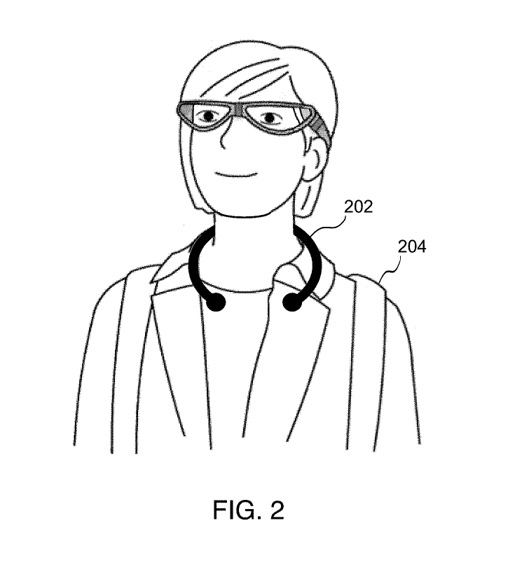

FIG. 2 illustrates a diagram of an example user device 202 being worn by a user 204, which may be used for some implementations described herein. In various implementations, user device 202 has an agent function, where a main agent (e.g., main agent 102) on user device 202 retrieves information from multiple remote agents or co-host agents (e.g., agent 112, agent 114, agent 116, etc.).

In various implementations, user device 202 is a wearable device. For example, in some implementations, user device 202 may be worn around the neck of user 204, as shown. While some implementations are described herein in the context of user device 202, which is worn by user 204 around the neck, these implementations and others may also apply to a variety of different types of user devices (e.g., headset, glasses, watch, smart phone, other electronics, etc.). Various user devices are possible, and the particular type of user device will depend on the particular implementation.

In some implementations, user device 202 may receive voice commands and requests from user 204. In some implementations, user device 202 may act on behalf of user 204 without user input. For example, user device 202 may automatically provide information to user 204 throughout the day (e.g. schedule information, recommendations, etc.).

In some implementations, user device 202 may provide relevant information to user 204 using audio such that only user 204 can hear the information. For example, user device 202 may shape the sound field to be around the person's ear using three-dimensional (3D) sound that is directed toward ears of user 204.

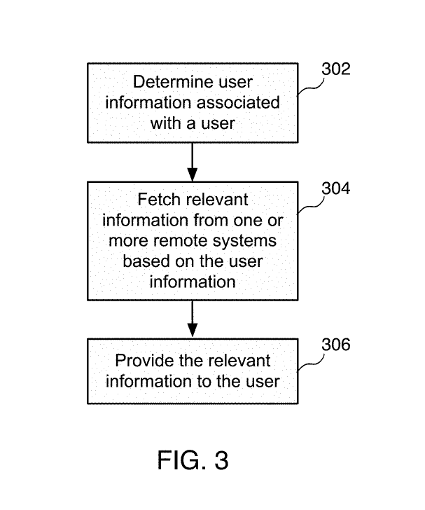

FIG. 3 illustrates an example flow diagram for operating an agent system for a device, according to some implementations. Referring to both FIGS. 1, 2, and 3, a method is initiated at block 302, where a system such as a client device (e.g., user device 202 of FIG. 2) determines user information associated with a user.

In some implementations, the user information may include location information, where the location information indicates the location of the user. For example, location information may include whether the user is home, or on a particular street, or in a particular part of town such as a district with food and entertainment, etc.

In some implementations, the user information may include time information. For example, time information may include various aspects of time. For example, in some implementations, the time information includes the time of day (e.g., 12:00 pm, 7:30 pm, etc.). In some implementations, the time information includes the day of the week (e.g., Tuesday, Friday, etc.). In some implementations, the time information includes the month of the year (e.g., April, July, etc.). In some implementations, the time information includes how long the user has been in a location (e.g., 25 minutes, 1 hour, etc.). In some implementations, the time information includes season, holidays, times and dates of celebrations and regional events, etc. (e.g., Halloween, Thanksgiving, etc.).

In some implementations, the user information includes activity information, where the activity information is based on activity of the user. In some implementations, the activity information includes a category of activity. For example, categories may include stationary activities (e.g., being home, being at work, etc.). Categories may also include movement activities (e.g., walking, running, etc.).

In some implementations, the activity information includes a predetermined activity (e.g., walking, running, biking, driving, etc.). Any given predetermined activity may fall into a particular category of activity. In various implementations, user information associated is customized to user 104, 204, and specific to the situation of user 104, 204.

In some implementations, agent 102 may collect sensor information to determine the location and activity of user 104, 204. Such sensor information may include data from a global positioning system (GPS), accelerometer, sports activity tracker, compass, etc. In some implementations, sensor data may include weather information such as temperature, wind chill and/or speed, light readings, humidity, etc. For example, agent 102 may determine that the user is walking, because the user is moving 2 miles an hour in a particular direction for more than 3 minutes. In another example, agent 102 may determine that the user is jogging, because the user is moving 5 miles an hour in a particular direction for more than 10 minutes.

At block 304, the system fetches relevant information from one or more remote systems based on the user information. In various implementations, the remote systems are third-party systems. For example, as indicated herein, agent 112 may be associated with a search engine company, agent 114 may be associated with an online calendar company, etc.

In various implementations, the relevant information that is fetched meets one or more relevance policies. In some implementations, the relevant information may include recommendations. In some implementations, one or more of the relevance policies includes providing one or more recommendations based on at least the proximity to the user. For example, relevant information may include a recommendation for a nearby restaurant. In some implementations, one or more of the relevance policies may be based on time. For example, a relevance policy may be to recommend restaurants around mealtimes (e.g., lunch, dinner, etc.). In some implementations, one or more of the relevance policies may be based on location. For example, a relevance policy may be to recommend restaurants that are within a predetermined walking distance (e.g., 0.1 miles, 0.25 miles, etc.). In some implementations, one or more of the relevance policies may be based on activity. For example, a relevance policy may be to recommend restaurants that are within biking distance if the user is on a bike (e.g., 0.5 miles, 1.0 miles, etc.).

In some implementations, agent 102 may determine the location and movement of user 104, 204. As such, agent 102 may predict the location of user 104, 204 at different times in order to provide user 104, 204 with relevant information at a particular time. For example, if user 104, 204 is on bike going a particular speed, agent 102 may provide recommendations for user 104, 204 based on where user will be located at a particular time. For example, agent 102 may recommend a restaurant two miles away after determining that user 104, 204 will be close to the restaurant in 20 minutes.

In various implementations, agent 102 determines the best source of particular information (e.g., scheduling information from a co-host agent that specializes in scheduling information. Agent 102 automatically makes such selections and decisions on behalf of the user.

At block 306, the system provides the relevant information to the user. In some implementations, the relevant information includes scheduling information, where one or more of the relevance policies includes providing a notice associated with a scheduled event based on at least time information.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

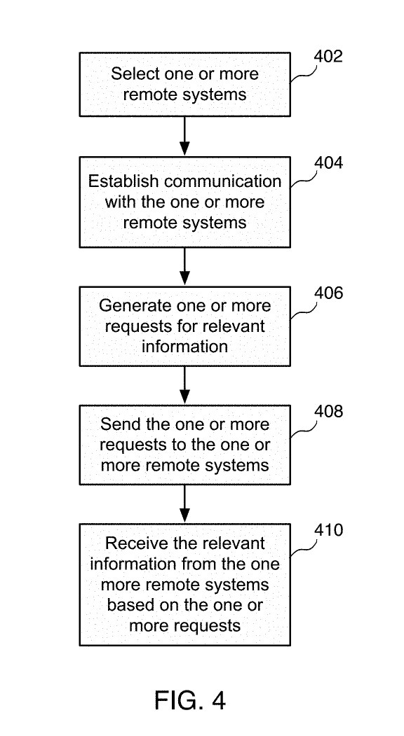

FIG. 4 illustrates an example flow diagram for fetching relevant information for a user, according to some implementations. Referring to both FIGS. 2 and 4, a method is initiated at block 402, where a system such as agent 102 of client device selects the one or more remote systems based on the user information. For example, if agent 102 determines that user 104, 204 is running (e.g., outdoors) and that it is close to lunchtime (e.g., 11:45 am), agent 102 may recommend a nearby restaurant for lunch.

At block 404, the system establishes communication with the one or more remote systems. At block 406, the system generates one or more requests for the relevant information based on one or more of the relevance policies. At block 408, the system sends the one or more requests to the one or more remote systems. As a result, the one or more remote co-host agents may then send the requested information to the system.

At block 410, the system (e.g., agent 102) receives the relevant information from the one or more remote systems based on the one or more requests. The system may then provide the relevant information to user 104, 204.

In some implementations, the fetching of the relevant information is performed without manual or voice input from the user. In some implementations, the fetching of the relevant information involves one or more intelligent personal assistants associated with the one more remote systems. In some implementations, an intelligent personal assistant is a software agent that performs tasks or services for an individual. Tasks may include making appointments, reservations, do to lists, reminders, notes, etc. Services include providing information, recommendations, calculations, prioritization, automated communication, data storage, collaboration between smart devices, etc.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

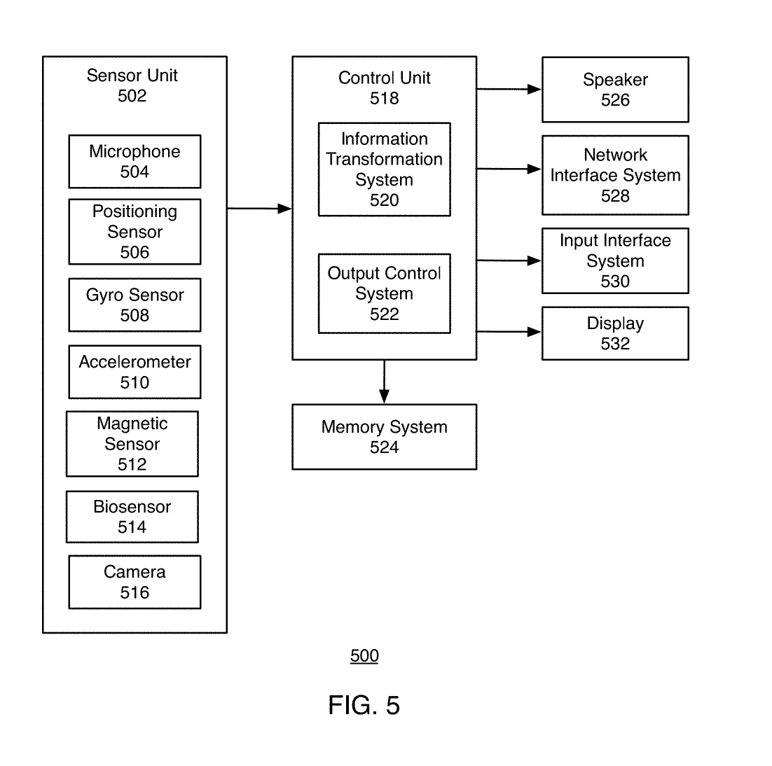

FIG. 5 is a schematic block diagram of an agent system 500. System 500 includes sensor unit 502. In various implementations, agent system 500 may reside on and/or be integrated with a user device such as user device 202 of FIG. 2. In some implementations, sensor unit 502 may include a microphone 504, a positioning sensor 506, a gyro sensor 508, an accelerometer 510, a magnetic sensor 512, a biosensor 514, and a camera 516.

System 500 also includes a control unit 518. In various implementations, control unit 518 may include an information transformation system 520 and an output control system 522. System 500 also includes a memory system 524, a speaker 526, a network interface system 528, an input interface system 530, and a display 532. Some of these components may be optional. For example, system 500 may or may not include an integrated display, and system 500 may output information to a display 532 in some implementations.

For ease of illustration, FIG. 5 shows one block for each type of component shown. These blocks may represent multiple components of each type. For example, there may be multiple speakers. In various implementations, system 500 may not have all of the components shown and/or may have other elements including other types of components instead of, or in addition to, those shown herein.

In some implementations, positioning sensor 506, which may depend on a global positioning system (GPS), WiFi, Bluetooth, or other suitable technologies. As shown, control unit 518 is operably connected to sensor unit 502, memory system 524, speaker 526, network interface system 528, input interface system 530, and display 532. Control unit 518 also includes one or more processors (not shown) that operates in conjunction with instructions and data from memory system 524, network interface system 528, and/or input interface system 530 (simple hardware devices such as a power button, a brightness control knob, etc.) to transform information gathered from sensor unit 502 into data usable by output control system of unit 522. In some implementations, this data and other information procured by agent system 500 may be provided to the user via components such as speaker 526, and some data and/or information may be provided to remote systems via network interface system 528, according to the particular applications being run in conjunction with agent system 500.

Embodiments described herein provide various benefits. In particular, embodiments enable a user to interact with one main agent conveniently in real time. The main agent functions as a master agent, which simplifies the search for information and coordination of information from different co-host agent sources. These benefits may also be valuable in engaging and maintaining user involvement in any of a variety of activities such as gaming, personal development and health, educational, and commercial or business applications.

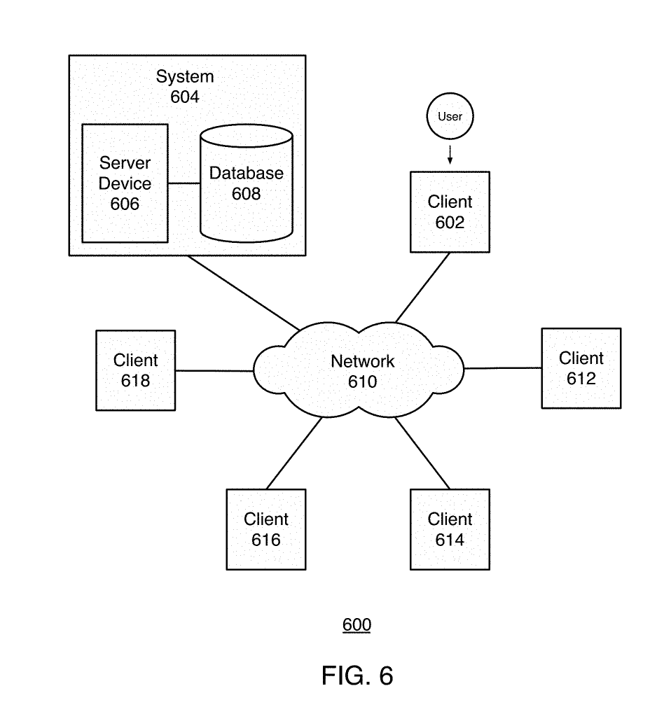

FIG. 6 illustrates a block diagram of an example network environment 600, which may be used for some implementations described herein. Implementations described herein may be implemented by a main agent on a client 602, or may be implemented by the agent in combination with a system 604. In some implementations, network environment 600 includes main agent on client 602 that communicates with system 604. System 604 may include a server device 606 and a database 608. Also shown is a network 610 through which main client 602 may communicate with remote client 612, 614, 616, and 618 associated co-hosts agents.

For ease of illustration, FIG. 6 shows one block for each various components of network environment 600. These blocks may represent components of each type of component. In other implementations, network environment 600 may not have all of the components shown and/or may have other elements including other types of elements instead of, or in addition to, those shown herein.

In the various implementations described herein, main agent on client 602 causes the elements described herein (e.g., relevant information, etc.) to be provided to the user (e.g., audibly, displayed in a user interface on one or more display screens, etc.).

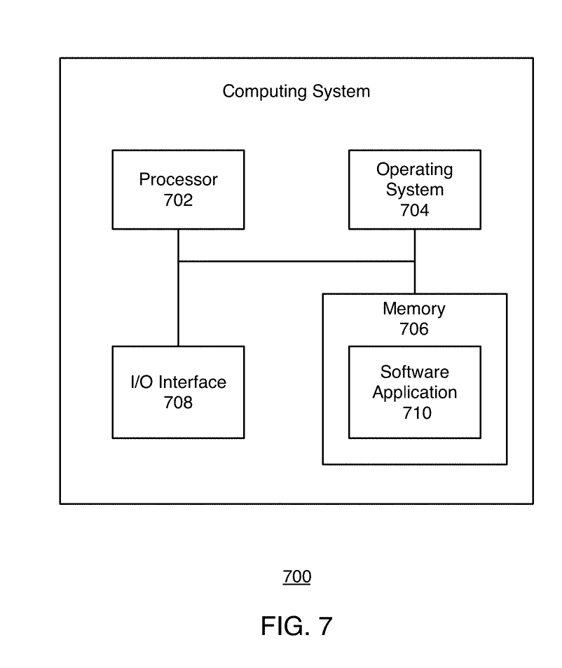

FIG. 7 illustrates a block diagram of an example computing system 700, which may be used for some implementations described herein. For example, computing system 700 may be used to implement user device 202 of FIG. 2, as well as to perform implementations described herein. In some implementations, computing system 700 may include a processor 702, an operating system 704, a memory 706, and an input/output (I/O) interface 708. In various implementations, processor 702 may be used to implement various functions and features described herein, as well as to perform the method implementations described herein. While processor 702 is described as performing implementations described herein, any suitable component or combination of components of computing system 700 or any suitable processor or processors associated with computing system 700 or any suitable system may perform the steps described. Implementations described herein may be carried out on a user device, on a server, or a combination of both.

Computing system 700 also includes a software application 710, which may be stored on memory 706 or on any other suitable storage location or computer-readable medium. Software application 710 provides instructions that enable processor 702 to perform the implementations described herein and other functions. Software application may also include an engine such as a network engine for performing various functions associated with one or more networks and network communications. The components of computing system 700 may be implemented by one or more processors or any combination of hardware devices, as well as any combination of hardware, software, firmware, etc.

For ease of illustration, FIG. 7 shows one block for each of processor 702, operating system 704, memory 706, I/O interface 708, and software application 710. These blocks 702, 704, 706, 708, and 710 may represent multiple processors, operating systems, memories, I/O interfaces, and software applications. In various implementations, computing system 700 may not have all of the components shown and/or may have other elements including other types of components instead of, or in addition to, those shown herein.

Although the description has been described with respect to particular embodiments thereof, these particular embodiments are merely illustrative, and not restrictive. Concepts illustrated in the examples may be applied to other examples and implementations.

In various implementations, software is encoded in one or more non-transitory computer-readable media for execution by one or more processors. The software when executed by one or more processors is operable to perform the implementations described herein and other functions.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a non-transitory computer-readable storage medium (also referred to as a machine-readable storage medium) for use by or in connection with the instruction execution system, apparatus, or device. Particular embodiments can be implemented in the form of control logic in software or hardware or a combination of both. The control logic when executed by one or more processors is operable to perform the implementations described herein and other functions. For example, a tangible medium such as a hardware storage device can be used to store the control logic, which can include executable instructions.

Particular embodiments may be implemented by using a programmable general purpose digital computer, and/or by using application specific integrated circuits, programmable logic devices, field programmable gate arrays, optical, chemical, biological, quantum or nanoengineered systems, components and mechanisms. In general, the functions of particular embodiments can be achieved by any means as is known in the art. Distributed, networked systems, components, and/or circuits can be used. Communication, or transfer, of data may be wired, wireless, or by any other means.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (SaaS) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

What is claimed is:

1. A computer-implemented method comprising:
determining, at a client device, user information associated with a user;
fetching relevant information from one or more remote systems based on the user information, wherein the one or more remote systems are third-party systems, and wherein the relevant information meets one or more relevance policies; and
providing the relevant information to the user.

2. The method of claim 1, wherein the user information comprises location information, and wherein the location information indicates a location of the user.

3. The method of claim 1, wherein the user information comprises time information.

4. The method of claim 1, wherein the user information comprises activity information, and where the activity information is based on activity of the user.

5. The method of claim 1, wherein the relevant information comprises recommendations, and wherein one or more of the relevance policies includes providing one or more recommendations based on at least a proximity to the user.

6. The method of claim 1, wherein the relevant information comprises scheduling information, and wherein one or more of the relevance policies includes providing a notice associated with a scheduled event based on at least time information.

7. The method of claim 1, wherein the fetching of the relevant information comprises:
selecting the one or more remote systems based on the user information;
establishing communication with the one or more remote systems;
generating one or more requests for the relevant information based on one or more of the relevance policies;
sending the one or more requests to the one or more remote systems; and
receiving the relevant information from the one or more remote systems based on the one or more requests.

8. A non-transitory computer-readable storage medium carrying program instructions thereon, the instructions when executed by one or more processors cause the one or more processors to perform operations comprising:
determining, at a client device, user information associated with a user;
fetching relevant information from one or more remote systems based on the user information, wherein the one or more remote systems are third-party systems, and wherein the relevant information meets one or more relevance policies; and
providing the relevant information to the user.

9. The computer-readable storage medium of claim 8, wherein the user information comprises location information, and wherein the location information indicates a location of the user.

10. The computer-readable storage medium of claim 8, wherein the user information comprises time information.

11. The computer-readable storage medium of claim 8, wherein the user information comprises activity information, and where the activity information is based on activity of the user.

12. The computer-readable storage medium of claim 8, wherein the relevant information comprises recommendations, and wherein one or more of the relevance policies includes providing one or more recommendations based on at least a proximity to the user.

13. The computer-readable storage medium of claim 8, wherein the relevant information comprises scheduling information, and wherein one or more of the relevance policies includes providing a notice associated with a scheduled event based on at least time information.

14. The computer-readable storage medium of claim 8, wherein the instructions when executed further cause the one or more processors to perform operations comprising:
selecting the one or more remote systems based on the user information;
establishing communication with the one or more remote systems;
generating one or more requests for the relevant information based on one or more of the relevance policies;
sending the one or more requests to the one or more remote systems; and
receiving the relevant information from the one or more remote systems based on the one or more requests.

15. A system comprising:
one or more processors; and
logic encoded in one or more non-transitory computer-readable storage media for execution by the one or more processors and when executed operable to perform operations comprising:
determining, at a client device, user information associated with a user;
fetching relevant information from one or more remote systems based on the user information, wherein the one or more remote systems are third-party systems, and wherein the relevant information meets one or more relevance policies; and
providing the relevant information to the user.

16. The system of claim 15, wherein the user information comprises location information, and wherein the location information indicates a location of the user.

17. The system of claim 15, wherein the user information comprises time information.

18. The system of claim 15, wherein the user information comprises activity information, and where the activity information is based on activity of the user.

19. The system of claim 15, wherein the relevant information comprises recommendations, and wherein one or more of the relevance policies includes providing one or more recommendations based on at least a proximity to the user.

20. The system of claim 15, wherein the relevant information comprises scheduling information, and wherein one or more of the relevance policies includes providing a notice associated with a scheduled event based on at least time information.
